(19) United States
(12) Patent Application Publication
(10) Pub. No.: US 2011/0304581 A1
(43) Pub. Date: Dec. 15, 2011

(54) Haptic feedback device and method for controlling the same

(75) Inventors: Seung Do An, Suwon (KR); Jong Hyeong Song, Suwon (KR); Jong Woo Han, Seongnam (KR)

(73) Assignee: SAMSUNG ELECTRO-MECHANICS CO., LTD., Suwon (KR)

(21) Appl. No.: 13/067,490

(22) Filed: Jun. 3, 2011

(30) Foreign Application Priority Data
Jun. 14, 2010 (KR) 10-2010-0055939

(51) Int. Cl. G06F 3/041

(52) U.S. Cl. 345/174

(57) ABSTRACT

A haptic feedback device includes a touch panel and an actuator. The touch panel is provided as a haptic device requiring a vibration. The actuator provides a driving force in a direction opposite to touch pressure provided to a touch surface of the touch panel when the touch pressure is less than a maximum critical touch pressure, and stops providing the driving force when the touch pressure is equal to or greater than the maximum critical touch pressure, so that the position of the touch panel changes according to the touch pressure.

### CROSS-REFERENCE TO RELATED APPLICATIONS

This application claims the priority of Korean Patent Application No. 10-2010-0055939 filed on Jun. 14, 2010, in the Korean Intellectual Property Office, the disclosure of which is incorporated herein by reference.

### BACKGROUND OF THE INVENTION

1. Field of the Invention

The present invention relates to a haptic feedback device and a method for controlling the same, and more particularly, to a haptic feedback device, which allows a user to feel as if he or she is pressing a dome switch of a real button, and a method for controlling the same.

2. Description of the Related Art

As users demand the convenient use of electronic products, the use of touch type devices in which data or commands are input by touching electronic products is becoming more common.

The concept of a haptic feedback device is to input data or commands by touch, reflect a user's intuitive experience with an interface, and diversify feedback with respect to a touch.

A haptic feedback device is advantageous in many aspects: it is space-saving and has enhanced and simple manipulation; it is easy to change a specification of a haptic feedback device; users are highly aware of a haptic feedback device; and it is also easy to interwork with IT appliances.

Due to these advantages, haptic feedback devices are widely used in electronic devices which are employed in computers, traffic services, medical services, mobile products, and so on.

A general haptic feedback device transfers a haptic feeling to a user by applying a vibration when a user presses a touch panel with his or her finger.

To this end, a vibration haptic is implemented using a vibration motor or a piezo actuator. Although such a vibration method is a simple vibration feedback or vibration transfer, it is not sufficient to transfer a high-quality click feeling to a user.

In this regard, there is a need for a haptic feedback device which can transfer a real click feeling with respect to touch pressure applied to a touch panel by a user, that is, a feeling such as that of an actual dome switch.

### SUMMARY OF THE INVENTION

An aspect of the present invention provides a haptic feedback device, which is capable of improving a click feeling by controlling a driving force of an actuator providing a vibration to a haptic device, and a method for controlling the same.

According to an aspect of the present invention, there is provided a haptic feedback device including: a touch panel provided as a haptic device requiring a vibration; and an actuator providing a driving force in a direction opposite to touch pressure provided to a touch surface of the touch panel when the touch pressure is less than a maximum critical touch pressure, and stopping providing the driving force when the touch pressure is equal to or greater than the maximum critical touch pressure, so that the position of the touch panel changes according to the touch pressure.

When the touch pressure is less than the maximum critical touch pressure, the actuator may generate the driving force corresponding to the touch pressure in a direction opposite to the touch pressure, so that the position of the touch panel does not change.

When the touch pressure is equal to or greater than the maximum critical touch pressure, the actuator may stop generating the driving force, so that the touch panel descends in a direction of the touch pressure.

According to another aspect of the present invention, there is provided a haptic feedback device including: a touch panel provided as a haptic device requiring a vibration and deformed in a direction of touch pressure when the touch pressure equal to or greater than a maximum critical touch pressure is provided to a touch surface thereof; and an actuator providing a driving force corresponding to the touch pressure in a direction of the touch pressure when the touch pressure of the touch panel decreases, and stopping providing the driving force when the touch pressure is equal to or less than a minimum touch pressure, so that the touch panel returns to an original position.

When the touch pressure exceeds the minimum critical touch pressure, the actuator may generate the driving force corresponding to the touch pressure in a direction of the touch pressure, so that the touch panel maintains a deformed state.

When the touch pressure is equal to or less than the minimum critical touch pressure, the actuator may stop generating the driving force, so that the touch panel ascends in a direction opposite to the touch pressure.

According to another aspect of the present invention, there is provided a method for controlling a haptic feedback device, including: providing touch pressure less than a maximum critical touch pressure to a touch surface of a touch panel provided as a haptic device requiring a vibration; operating an actuator, which is provided on a surface opposite to the touch surface, to provide a driving force opposite to the touch pressure in a direction of the touch surface; and stopping providing the driving force of the actuator when the touch pressure is equal to or greater than the maximum critical touch pressure, so that the position of the touch panel changes according to the touch pressure.

When the touch pressure is less than the maximum critical touch pressure, the actuator may generate the driving force corresponding to the touch pressure in a direction opposite to the touch pressure, so that the position of the touch panel does not change.

When the touch pressure is equal to or greater than the maximum critical touch pressure, the actuator may stop generating the driving force, so that the touch panel descends in a direction of the touch pressure.

According to another aspect of the present invention, there is provided a method for controlling a haptic feedback device, including: providing touch pressure equal to or greater than a maximum critical touch pressure to a touch surface of a touch panel provided as a haptic device requiring a vibration, so that a touch panel is deformed in a direction of the touch pressure; operating an actuator, which is provided on a surface opposite to the touch surface, to provide a driving force opposite to the touch pressure in a direction of the touch pressure until before the touch pressure decreases and reaches a minimum critical touch pressure; and stopping providing the driving force of the actuator when the touch pressure is equal to or less than the minimum critical touch pressure, so that the deformed touch panel returns to an original position.

When the touch pressure exceeds the minimum critical touch pressure, the actuator may generate the driving force corresponding to the touch pressure in a direction of the touch pressure, so that the touch panel maintains the deformed state.

When the touch pressure is equal to or less than the minimum critical touch pressure, the actuator may stop generating the driving force, so that the touch panel ascends in a direction opposite to the touch pressure.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of a mobile communication terminal which is an electronic device according to an embodiment of the present invention;

FIG. 2 is a schematic perspective view of a haptic feedback device according to an embodiment of the present invention when it is mounted on a mobile communication terminal case;

FIG. 3 is a schematic perspective view of the haptic feedback device according to the embodiment of the present invention;

FIG. 4 is a schematic cross-sectional view of the haptic feedback device according to the embodiment of the present invention;

FIG. 5 is a schematic cross-sectional view of the haptic feedback device according to the embodiment of the present invention when touch pressure is applied to a touch panel thereof;

FIG. 6 is a schematic cross-sectional view of the haptic feedback device according to the embodiment of the present invention when touch pressure applied to a touch panel thereof is equal to a maximum critical touch pressure;

FIG. 7 is a schematic cross-sectional view of a haptic feedback device according to another embodiment of the present invention when touch pressure is applied to a touch panel thereof;

FIG. 8 is a schematic cross-sectional view of the haptic feedback device according to another embodiment of the present invention when touch pressure applied to a touch panel thereof is equal to a maximum critical touch pressure; and

FIG. 9 is a flowchart illustrating a method for controlling a haptic feedback device according to another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

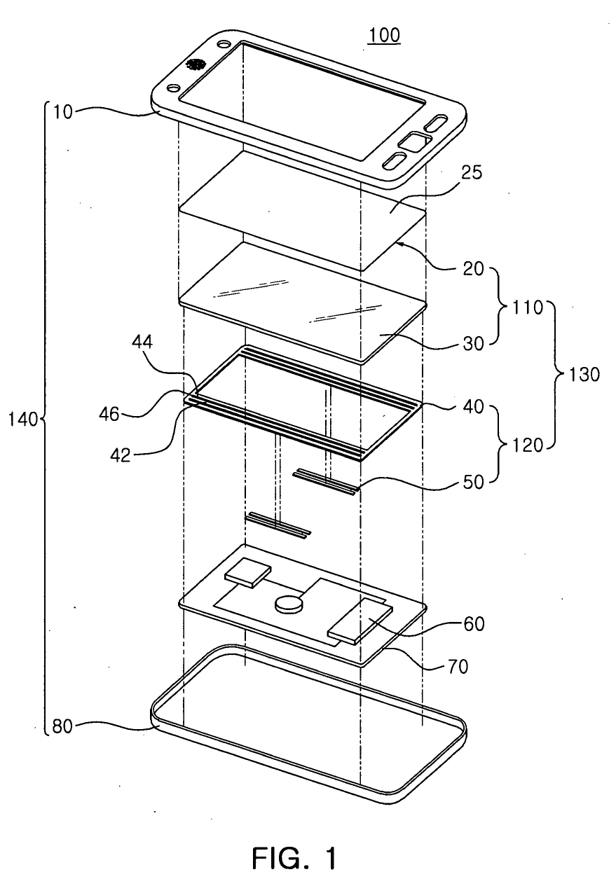

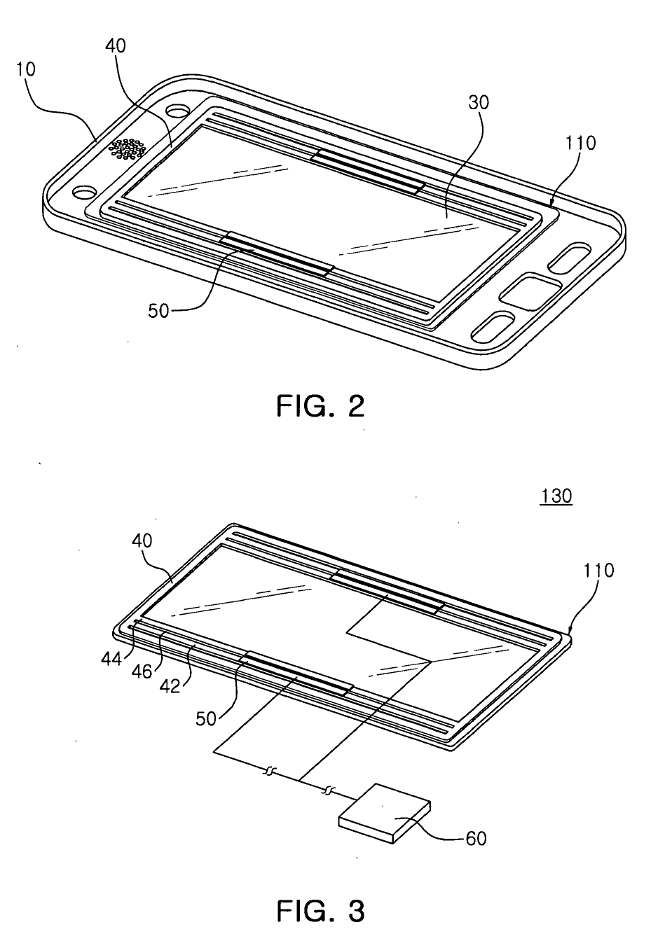

FIG. 1 is an exploded perspective view of a mobile communication terminal which is an electronic device according to an embodiment of the present invention. FIG. 2 is a schematic perspective view of a haptic feedback device according to an embodiment of the present invention when it is mounted on a mobile communication terminal case. FIG. 3 is a schematic perspective view of the haptic feedback device according to the embodiment of the present invention.

Referring to FIGS. 1 through 3, the mobile communication terminal 100 which is the electronic device according to the embodiment of the present invention may include a case 140 and a haptic feedback device 130.

The case 140 may include a front case 10 and a rear case 80. An inner space may be realized by the assembly of the front case 10 and the rear case 80.

The haptic feedback device 130 may be mounted within the inner space. The haptic feedback device 130 includes a haptic feedback actuator 120 which may be operated by a control unit 60 mounted on a circuit board 70.

The haptic feedback device 130 may include a haptic device 110 and the haptic feedback actuator 120.

The haptic device 110 is a mechanical component which requires a vibration and an internal component of the mobile communication terminal 100 which responds to an external touch pressure.

The haptic device 110 may be used in a display panel 30 of the mobile communication terminal 100 and a variety of input devices requiring a vibration according to a touch, for example, OA products, vending machines, ticket dispensers, and so on.

The haptic device 110 may include the display panel 30 displaying an image, and a touch panel 20 to which a pressure is directly applied from the outside. That is, when touch pressure is applied to a touch surface 25 of the touch panel 20 and the touch pressure changes, the haptic device 110 delivers a haptic response to the touch pressure.

The touch panel 20 may be formed by laminating an outer film, an indium-tin-oxide (ITO) film, and a base film. The display panel 30 is disposed on the bottom of the touch panel 20 and emits light to the front surface of the mobile communication terminal 100.

Examples of the display panel 30 may include a liquid crystal display (LCD), a plasma display panel (PDP), and an electroluminescence (EL) display; however, the display panel 30 is not limited thereto.

The haptic feedback actuator 120 may include a vibration plate 40 and an actuator 50. Also, the haptic feedback device 130 is a concept that may include the haptic device 110 with the touch panel 20 to which touch pressure is applied, and the haptic feedback actuator 120 vibrating the haptic device 110.

The vibration plate 40 may transfer the vibrations generated by the actuator 50 to the display panel 30. The actuator 50 may be directly attached to the display panel 30 to vibrate the display panel 30. The vibration plate 40 may be selectively used if necessary to relieve or amplify the impact of the vibrations.

That is, the vibration plate 40 constituting the haptic feedback actuator 120 is an optional component.

The vibration plate 40 may be manufactured by injecting an impact relieving material, but the invention is not limited thereto. The thickness of the vibration plate 40 may be changed considering the interaction with the actuator 50.

The vibration plate 40 may be formed as a thin strip and disposed along the edge of the rectangular display panel 30.

In the rectangular display panel 30, the long side is defined as a length direction and the short side is defined as a width direction.

Specifically, the vibration plate 40 may include a plurality of branch lines 42 and 44 at the length-direction edges of the display panel 30 of the haptic device 110, and slits 46 may be formed between the branch lines 42 and 44.

The branch lines 42 and 44 may have a substantially equal width, and the bar-shaped actuator 50 having a width substantially equal to that of the branch lines 42 and 44 may be attached to the branch lines 42 and 44. In this case, the actuator 50 may be disposed to be parallel to the branch lines 42 and 44.

A position at which the actuator 50 is attached to the vibration plates 40 is not limited to the center portions of the branch lines 42 and 44. The actuator 50 may lean to the right or left. A plurality of actuators 50 may be disposed on the branch lines 42 and 44.

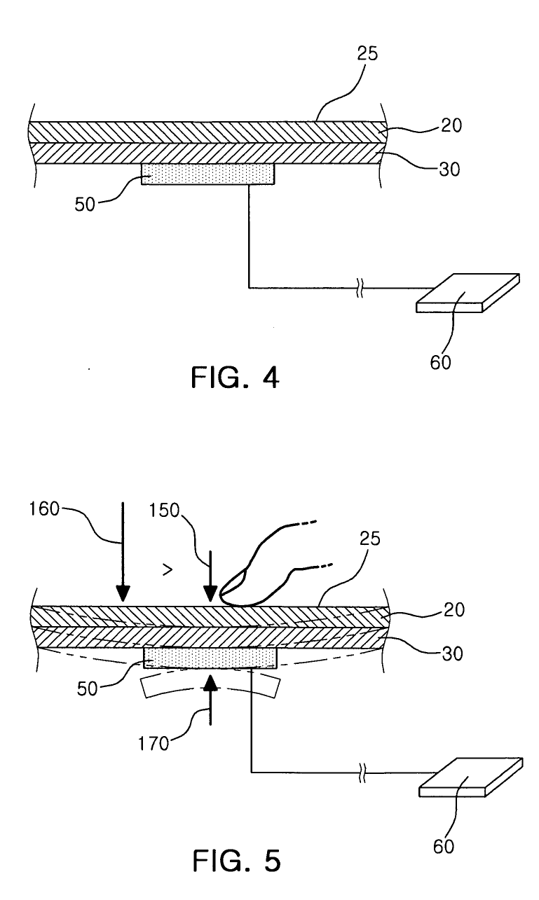

The operation of the actuator 50 and the position change of the touch panel 20 will be described below with reference to FIGS. 4 through 8.

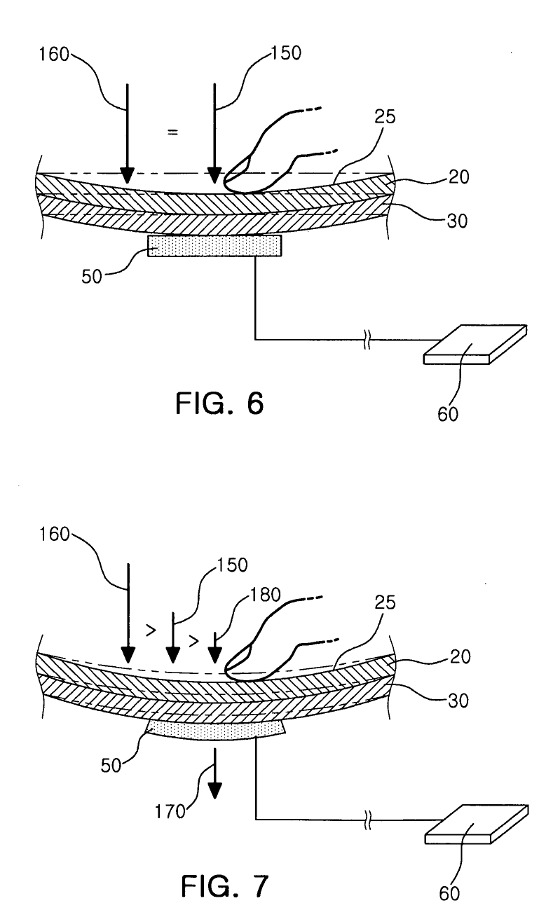

FIG. 4 is a schematic cross-sectional view of the haptic feedback device according to the embodiment of the present invention. FIG. 5 is a schematic cross-sectional view of the haptic feedback device according to the embodiment of the present invention when touch pressure is applied to the touch panel thereof. FIG. 6 is a schematic cross-sectional view of the haptic feedback device according to the embodiment of the present invention when touch pressure applied to the touch panel thereof is equal to a maximum critical touch pressure.

Referring to FIGS. 4 through 6, the haptic feedback device 130 according to the embodiment of the present invention may include the haptic device 110 with the touch panel 120 to which touch pressure is applied, and the haptic feedback actuator 120 vibrating the haptic device 110.

As described above, although the haptic feedback device 130 includes the display panel 30, the following description will be focused on the touch panel 20 and the actuator 50.

The actuator 50 constituting the haptic feedback device 130 may be operated by the control unit 60 mounted on the circuit board 70, and a user's touch pressure 150 is provided to the touch surface 25 of the touch panel 20.

As illustrated in FIG. 5, the touch pressure 150 is provided to the haptic device 110 including the touch panel 20, and the touch pressure 150 is transferred to the control unit 60.

A maximum critical touch pressure 160 determining whether or not to drive the actuator 50 is previously set in the control unit 60. The control unit 60 compares the magnitude of the touch pressure 150 with the magnitude of the maximum critical touch pressure 160.

The magnitudes of the touch pressure 150, the maximum critical touch pressure 160, and a minimum critical touch pressure 180, which will be described later, are expressed by the lengths of the arrows in the drawings.

When the touch pressure 150 is less than the maximum critical touch pressure 160, the actuator 50 is driven to generate a driving force 170 by the signal of the control unit 60.

That is, when the touch pressure 150 less than the maximum critical touch pressure 160 is applied to the touch panel 20, the touch panel 20 is bent in a direction of the touch pressure 150 by the touch pressure 150, as indicated by the dotted lines.

However, the control unit 60 transfers a driving signal to the actuator 50 in order to prevent the bending of the touch panel 20. The actuator 50 receiving the driving signal provides the driving force 170 opposite to the touch pressure 150 in a direction of the touch surface 25 of the touch panel 20. Thus, the position of the touch panel 20 does not change in spite of the touch pressure 150.

Therefore, the actuator 50 provides the touch panel 20 with the driving force corresponding to the touch pressure 150 until the touch pressure 150 gradually increases and reaches the maximum critical touch pressure 160, the user providing the touch pressure 150 has no feeling from the touch panel 20, in spite of the touch pressure 150.

As illustrated in FIG. 6, when the touch pressure 150 is greater than or equal to the maximum critical touch pressure 160, the actuator 50 is stopped without generating the driving force.

That is, when the touch pressure is greater than or equal to the maximum critical touch pressure 160, the control unit 60 transfers a control signal which stops the operation of the actuator 50.

The actuator 50 receiving the control signal stops providing the driving force 170 corresponding to the touch pressure 150 in a direction of the touch surface 25 of the touch panel 20. Thus, the touch panel 20 descends in a direction of the touch pressure 150.

Therefore, due to the driving force of the actuator 50, the touch panel 20 is not deformed until before the touch pressure 150 reaches the maximum critical touch pressure 160. Since the touch panel 20 responds to the touch pressure 150 at the moment the touch pressure 150 reaches the maximum critical touch pressure 160, the user providing the touch pressure 150 can have a click feeling as if he or she presses a real button.

Also, since the control unit 60 variably stores the maximum critical touch pressure 160, the user providing the touch pressure 150 can have a variety of button click feelings.

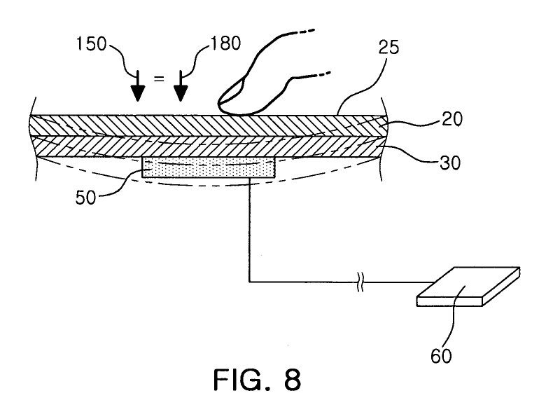

FIG. 7 is a schematic cross-sectional view of a haptic feedback device according to another embodiment of the present invention when touch pressure is applied to a touch panel thereof. FIG. 8 is a schematic cross-sectional view of the haptic feedback device according to another embodiment of the present invention when touch pressure applied to a touch panel thereof is equal to a maximum critical touch pressure.

FIG. 7 is a cross-sectional view illustrating how the touch pressure 150 acts after the touch pressure 150 reaches the maximum critical touch pressure 160 and the touch panel 20 descends. The touch panel 20 descends in a direction of the touch pressure 150.

That is, after the user clicks the touch panel 20 and has a click feeling, the touch pressure 150 with respect to the touch panel 20 decreases and the touch of the touch panel disappears.

At this time, the touch pressure 150 gradually decreases after it reaches the maximum critical touch pressure 160, and the control unit 60 compares the touch pressure 150 with a minimum critical touch pressure 180.

Therefore, when the touch pressure 150 exceeds the minimum critical touch pressure 180, the control unit 60 applies a driving signal to the actuator 50, and the actuator 50 provides a driving force 170 corresponding to the touch pressure 150 in a direction of the touch pressure 150.

That is, when the touch pressure 150 exceeds the minimum critical touch pressure 180, the driving force corresponding to the touch pressure 150 is generated in a direction of the touch pressure 150, so that the touch panel 20 maintains the deformed state.

When the touch pressure 150 gradually decreases below the minimum critical touch pressure 180, the actuator 50 is stopped without generating the driving force any more, as illustrated in FIG. 8.

That is, when the touch pressure 150 is equal to or less than the minimum critical touch pressure 180, the control unit 60 transfers a control signal which stops the operation of the actuator 50.

The actuator 50 receiving the control signal stops providing the driving force 170 corresponding to the touch pressure 150 in a direction of the touch pressure 150. Thus, the touch panel 20 returns to the original position.

Therefore, due to the driving force of the actuator 50, the touch panel 20 is not deformed until before the touch pressure 150 reaches the minimum critical touch pressure 180. The touch panel 20 ascends and returns to the original position at the moment the touch pressure 150 reaches the minimum critical touch pressure 180.

Hence, the user providing the touch pressure 150 can feel a button up while feeling increase of a force due to the ascending effect of the touch panel 20.

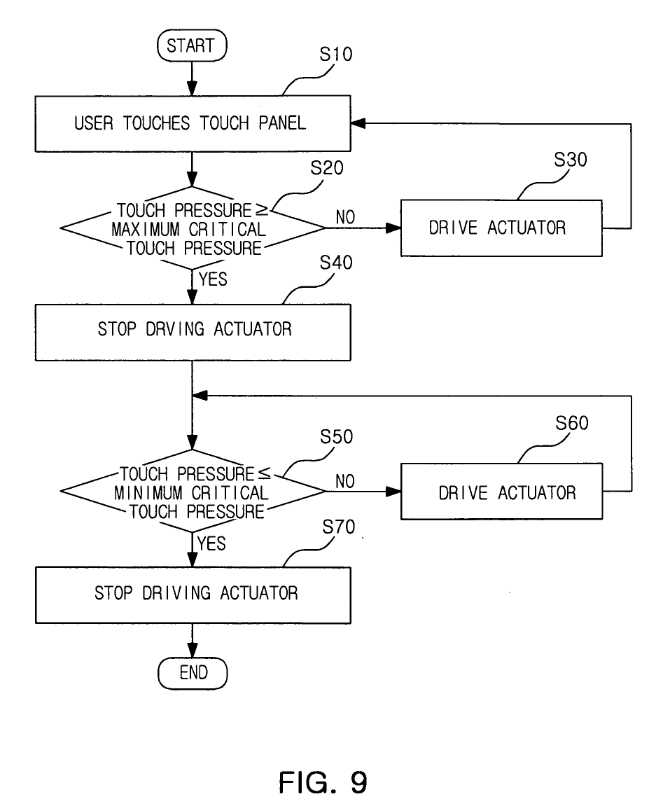

FIG. 9 is a flowchart illustrating a method for controlling a haptic feedback device according to another embodiment of the present invention. The method for controlling the haptic feedback device 130 will be described below with reference to FIG. 9.

When the user touches the touch panel 20 and generates the touch pressure 150 (S10), the control unit 60 senses the touch pressure 150 and compares the touch pressure 150 with the previously stored maximum critical touch pressure 160 (S20).

When the touch pressure 150 is less than the maximum critical touch pressure 160, the control unit 60 applies the driving signal to the actuator 50.

The actuator 50 generates the driving force corresponding to the touch pressure 150 according to the driving signal (S30).

When the touch pressure 150 reaches the maximum critical touch pressure 160, the actuator 50 stops generating the driving force 170 (S40). Thus, the touch panel 20 descends in a direction of the touch pressure 150 in response to the touch pressure 150.

The user providing the touch pressure 150 has a button click feeling and the touch pressure 150 gradually decreases.

The control unit 60 compares the touch pressure 150 with the previously stored minimum critical touch pressure 180 (S50). When the touch pressure 150 is greater than the minimum critical touch pressure 180, the actuator 50 again generates the driving force (S60).

Due to the driving force of the actuator 50, the touch panel 20 maintains the descending state.

When the touch pressure 150 reaches the minimum critical touch pressure 180, the actuator 50 stops generating the driving force (S70), and the touch panel 20 returns the original state. Hence, the user can feel the button up.

As described above, since whether to drive the actuator 50 is determined by the maximum critical touch pressure 160 and the minimum critical touch pressure 180 which are previously stored in the control unit 60, the user providing the touch pressure can feel a button clicking as if he or she presses a dome switch.

Furthermore, since the control unit 60 can variably store the maximum critical touch pressure 160, the user providing the touch pressure can have a variety of button click feelings.

The haptic feedback device and the method for controlling the same according to the embodiments of the present invention can provide a user with a click feeling as if the user presses a dome switch.

Moreover, a variety of click feelings can be provided by adjusting the maximum critical touch pressure of the touch panel.

While the present invention has been shown and described in connection with the exemplary embodiments, it will be apparent to those skilled in the art that modifications and variations can be made without departing from the spirit and scope of the invention as defined by the appended claims.

What is claimed is:

1. A haptic feedback device comprising:
a touch panel provided as a haptic device requiring a vibration; and
an actuator providing a driving force in a direction opposite to touch pressure provided to a touch surface of the touch panel when the touch pressure is less than a maximum critical touch pressure, and stopping providing the driving force when the touch pressure is equal to or greater than the maximum critical touch pressure, so that the position of the touch panel changes according to the touch pressure.

2. The haptic feedback device of claim 1, wherein, when the touch pressure is less than the maximum critical touch pressure, the actuator generates the driving force corresponding to the touch pressure in a direction opposite to the touch pressure, so that the position of the touch panel does not change.

3. The haptic feedback device of claim 1, wherein, when the touch pressure is equal to or greater than the maximum critical touch pressure, the actuator stops generating the driving force, so that the touch panel descends in a direction of the touch pressure.

4. A haptic feedback device comprising:
a touch panel provided as a haptic device requiring a vibration and deformed in a direction of touch pressure when the touch pressure equal to or greater than a maximum critical touch pressure is provided to a touch surface thereof; and
an actuator providing a driving force corresponding to the touch pressure in a direction of the touch pressure when the touch pressure of the touch panel decreases, and stopping providing the driving force when the touch pressure is equal to or less than a minimum touch pressure, so that the touch panel returns to an original position.

5. The haptic feedback device of claim 4, wherein, when the touch pressure exceeds the minimum critical touch pressure, the actuator generates the driving force corresponding to the touch pressure in a direction of the touch pressure, so that the touch panel maintains a deformed state.

6. The haptic feedback device of claim 4, wherein, when the touch pressure is equal to or less than the minimum critical touch pressure, the actuator stops generating the driving force, so that the touch panel ascends in a direction opposite to the touch pressure.

7. A method for controlling a haptic feedback device, comprising:
providing touch pressure less than a maximum critical touch pressure to a touch surface of a touch panel provided as a haptic device requiring a vibration;
operating an actuator, which is provided on a surface opposite to the touch surface, to provide a driving force opposite to the touch pressure in a direction of the touch surface; and
stopping providing the driving force of the actuator when the touch pressure is equal to or greater than the maximum critical touch pressure, so that the position of the touch panel changes according to the touch pressure.

8. The method of claim 7, wherein, when the touch pressure is less than the maximum critical touch pressure, the actuator generates the driving force corresponding to the touch pressure in a direction opposite to the touch pressure, so that the position of the touch panel does not change.

9. The method of claim 7, wherein, when the touch pressure is equal to or greater than the maximum critical touch pressure, the actuator stops generating the driving force, so that the touch panel descends in a direction of the touch pressure.

10. A method for controlling a haptic feedback device, comprising:
providing touch pressure equal to or greater than a maximum critical touch pressure to a touch surface of a touch panel provided as a haptic device requiring a vibration, so that a touch panel is deformed in a direction of the touch pressure;
operating an actuator, which is provided on a surface opposite to the touch surface, to provide a driving force opposite to the touch pressure in a direction of the touch pressure until before the touch pressure decreases and reaches a minimum critical touch pressure; and
stopping providing the driving force of the actuator when the touch pressure is equal to or less than the minimum critical touch pressure, so that the deformed touch panel returns to an original position.

11. The method of claim 10, wherein, when the touch pressure exceeds the minimum critical touch pressure, the actuator generates the driving force corresponding to the touch pressure in a direction of the touch pressure, so that the touch panel maintains the deformed state.

12. The method of claim 10, wherein, when the touch pressure is equal to or less than the minimum critical touch pressure, the actuator stops generating the driving force, so that the touch panel ascends in a direction opposite to the touch pressure.
